(19) United States
(12) Patent Application Publication
(10) Pub. No.: US 2007/0163375 A1
(43) Pub. Date: Jul. 19, 2007

(54) Rack yoke assembly for use in a rack and pinion steering apparatus

(75) Inventor: Eric C. Counts, Surgoinsville, TN (US)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW AUTOMOTIVE U.S. LLC

(21) Appl. No.: 11/332,100

(22) Filed: Jan. 16, 2006

(51) Int. Cl. F16H 1/04; F16H 35/00

(52) U.S. Cl. 74/422; 74/388 PS

(57) ABSTRACT

A yoke assembly for supporting a rack in a rack and pinion steering apparatus comprises a yoke portion having a seat and a spring portion formed from a single continuous piece of material; and a carrier portion configured to retain the rack yoke portion with the rack and pinion steering assembly. The spring portion of the rack yoke portion includes at least a pair of arms having first portions and second portions, wherein the second portions are configured to pivot about a hinge formed between the first portions and second portions.

### BACKGROUND OF THE INVENTION

This invention relates in general to a rack and pinion steering apparatus and in particular to a rack yoke assembly for supporting a rack in such a rack and pinion steering apparatus.

A rack and pinion steering apparatus has a housing containing a rack and a pinion. The rack has a longitudinally extending row of rack teeth in meshing engagement with helical gear teeth on the pinion. The opposite ends of the rack bar project outward from the housing and are connected with a steering linkage and a corresponding pair of steerable vehicle wheels. The pinion is connected with the vehicle steering wheel by an input shaft and a torsion bar. When a steering maneuver is being performed the pinion rotates and the rack bar moves longitudinally. The housing also contains a spring loaded yoke assembly that presses the rack bar against the pinion to maintain the rack teeth in meshing engagement with the gear teeth on the pinion.

### SUMMARY OF THE INVENTION

This invention relates to a yoke assembly for supporting a rack in a rack and pinion steering apparatus. The rack yoke assembly comprises a yoke portion having a seat and a spring portion formed from a single continuous piece of material; and a carrier portion configured to retain the rack yoke portion with the rack and pinion steering assembly. The spring portion of the rack yoke portion includes at least a pair of arms having first portions and second portions, wherein the second portions are configured to pivot about a hinge formed between the first portions and second portions.

Other advantages of this invention will become apparent to those skilled in the art from the following detailed description of the invention, when read in light of the accompanying drawings.

### BRIEF DESCRIPTION OF THE DRAWINGS

FIG. 1 is a sectional view of a prior art rack and pinion steering apparatus.

FIG. 2 is a cross-sectional view through line 2-2 of FIG. 1, showing the prior art rack yoke assembly.

FIG. 3 is an exploded perspective view of a rack yoke assembly according to the present invention.

FIG. 4 is an exploded plan view of the rack yoke assembly according to the present invention.

FIG. 5 is a cross-sectional view similar to prior art FIG. 2 but including the rack yoke assembly shown in FIGS. 3 and 4 according to the present invention.

FIG. 6 is an exploded plan view of a rack yoke assembly according to an alternate embodiment of the present invention.

FIG. 7 is a cross-sectional view similar to FIG. 5, but including the rack yoke assembly shown in FIG. 6 according to the present invention.

FIG. 8 is an exploded plan view of a rack yoke assembly according to yet another alternate embodiment of the present invention.

FIG. 9 is a cross-sectional view similar to FIG. 5, but including the rack yoke assembly shown in FIG. 8 according to the present invention.

### DETAILED DESCRIPTION OF THE INVENTION

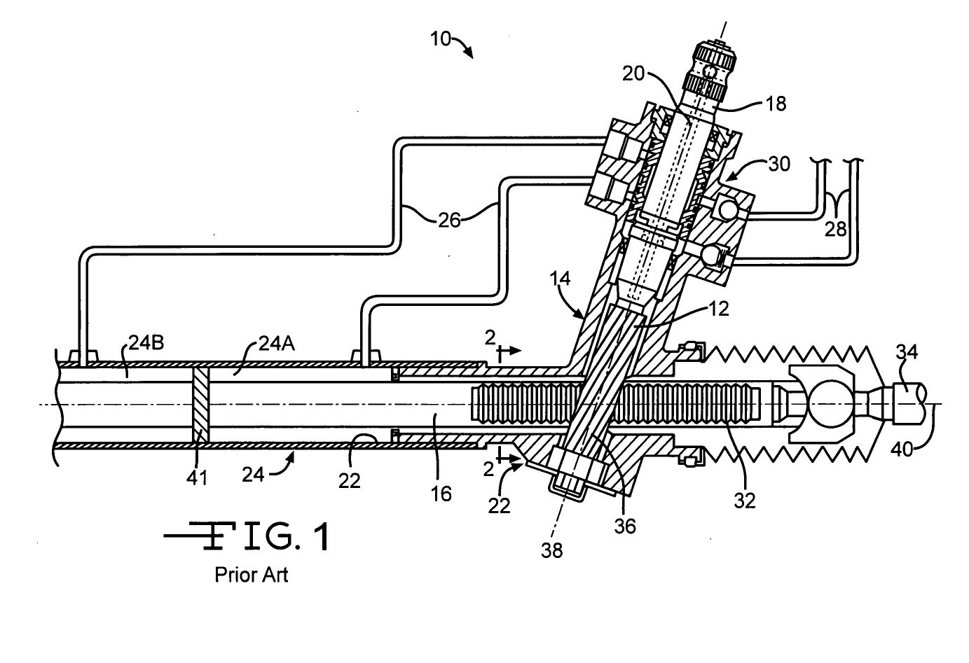

Referring now to the drawings, there is illustrated in prior art FIG. 1 a portion of a hydraulically assisted rack and pinion steering apparatus, indicated generally at 10. The prior art steering apparatus 10 includes a pinion 12, a housing 14, a rack bar 16, an input shaft 18, and a torsion bar 20. It can be appreciated that while the power assisted steering assembly 10 described below is a hydraulically assisted power steering assembly, the steering assembly could also be an electronically controlled power steering assembly.

The housing 14 has a hydraulic valve section 30 and an axially extending passage 22 through which the rack bar 16 extends. A rack chamber 24 is defined in the passage 22 of the housing 14. Hydraulic lines 26 provide fluid communication between the rack chamber 24 and the valve section 30 of the housing 14. Hydraulic conduits 28 provide fluid communication between the valve section 30 and a power steering pump (not shown) as is known in the art.

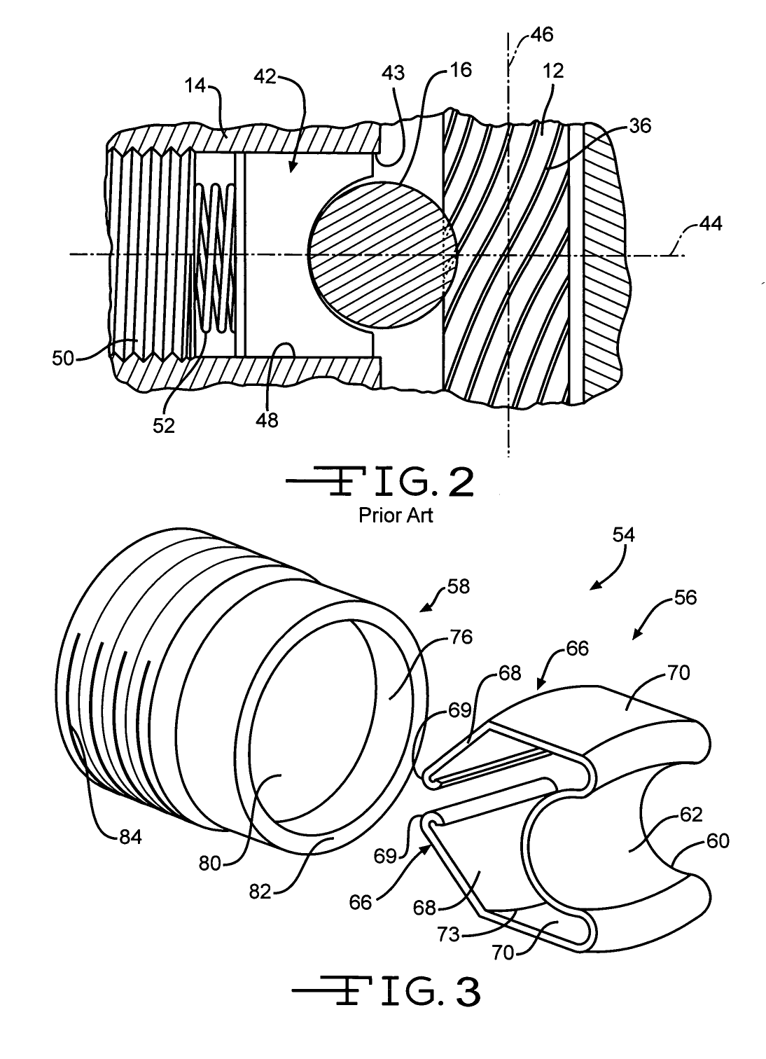

A piston 41 is connected to the rack bar 16 and is disposed in the rack chamber 24 separating the chamber 24 into two rack chambers 24A and 24B. The separated rack chamber 24 allows hydraulic fluid to selectively be supplied to one of the opposed chambers 24A and 24B depending on the steering maneuver being performed. The rack bar 16 includes a section having rack teeth 32. The rack teeth 32 are meshed with helical teeth 36, described further below, on the pinion 12 inside the housing 14. Opposite ends of the rack bar 16 are connected with steerable vehicle wheels (not shown) by pivotable tie rods, one of which is shown at 34 as is known in the art. When a steering maneuver is being performed, the pinion 12 rotates about the axis 38, and the rack bar 16 moves longitudinally within the passage 22 along a horizontal axis 40. Positioned substantially perpendicular to the axially extending passage 22 is a yoke bore 48 (shown in prior art FIG. 2) that connects with the passage 22 within the housing 14. The yoke bore 48 defines an axis 44 that intersects the horizontal axis 40.

Illustrated in prior art FIG. 2, there is shown a cross-sectional view of the rack and pinion steering apparatus shown in prior art FIG. 1, including a generally conventional rack yoke, indicated generally at 42. The rack yoke 42 is a generally cylindrical part centered on the axis 44 that is perpendicular to the axis 40 of the rack bar 16. As further shown in prior art FIG. 2, the rack yoke 42 is contained in a generally cylindrical yoke bore 48 of the housing 14 between a closure cap 50 and the rack bar 16. The yoke bore 48 includes an inner surface 43. A spring 52 is disposed and compressed between the rack yoke 42 and the closure cap 50. The spring 52 applies an axially directed preloading force which urges the rack yoke 42 forcefully against the rack bar 16 in a direction from left to right as viewed in prior art FIG. 2. The rack yoke 42 in turn applies the preloading force to the rack bar 16 so as to hold the rack teeth 32 firmly in mesh with the helical teeth 36 on the pinion 12.

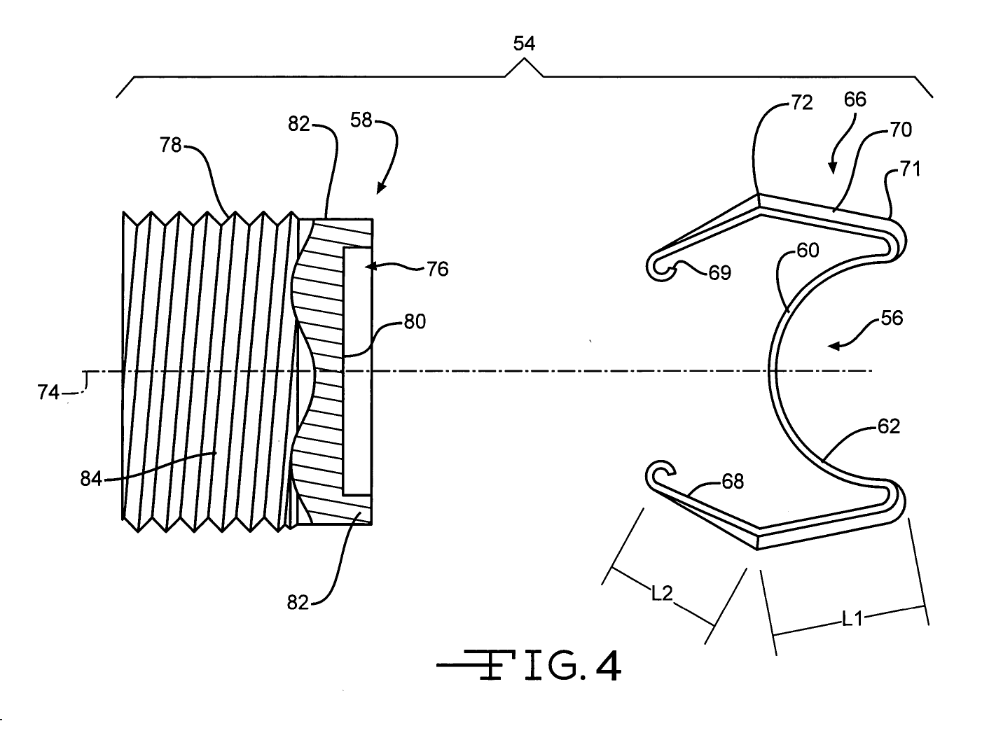

Illustrated in FIG. 3 is an exploded view of a rack yoke assembly, indicated generally at 54, according to the present invention. As shown, there is a yoke portion, indicated generally at 56 and a carrier portion, indicated generally at 58. In the illustrated embodiment, the yoke portion 56 includes a generally U-shaped seat 60 that defines a rack engaging surface 62 and a pair of arms 66 that extend away from the seat 60. The rack engaging surface 62 is preferably curved to form the upper portion of the U-shape of the seat 60. It should be appreciated that the curved rack engaging surface 62 can be of any desired shape, such as for example, semi-circular, semi-elliptical, arched, or the like. In addition, the rack engaging surface 62 can have any suitable shape that corresponds to the shape of the rack bar 16. The rack engaging surface 62 of the seat 60 comprises the surface that is in substantially direct engagement with the rack bar 16 since the rack engaging surface 62 is the portion of the seat 60 that is forced into contact with the rack bar 16. Therefore, in the illustrated embodiment, it can be appreciated that the rack engaging surface 62 is preferably shaped to closely conform to or match the surface or contour of the rack bar 16 which it engages. In addition, the rack yoke assembly 54 partially supports and guides the axial movement of the rack bar 16 relative to the pinion 12. Therefore, in the illustrated embodiment, the rack engaging surface 62 is preferably coated with a low friction coating such as Teflon impregnated bronze or a similar coating. It should be appreciated that the yoke portion 56 can also be made from a material such as a plastic, nylon, or Kevlar-based material, or can be coated with a Teflon or other low friction material. Both Teflon and Kevlar are products that are commercially available from and are registered trademarks of E. I. DuPont de Nemours and Co. of Wilmington, Delaware. It should be appreciated that any suitable material can be used to form the seat 60 to provide a substantially low wear contact surface between the rack yoke assembly 54 and the rack bar 16.

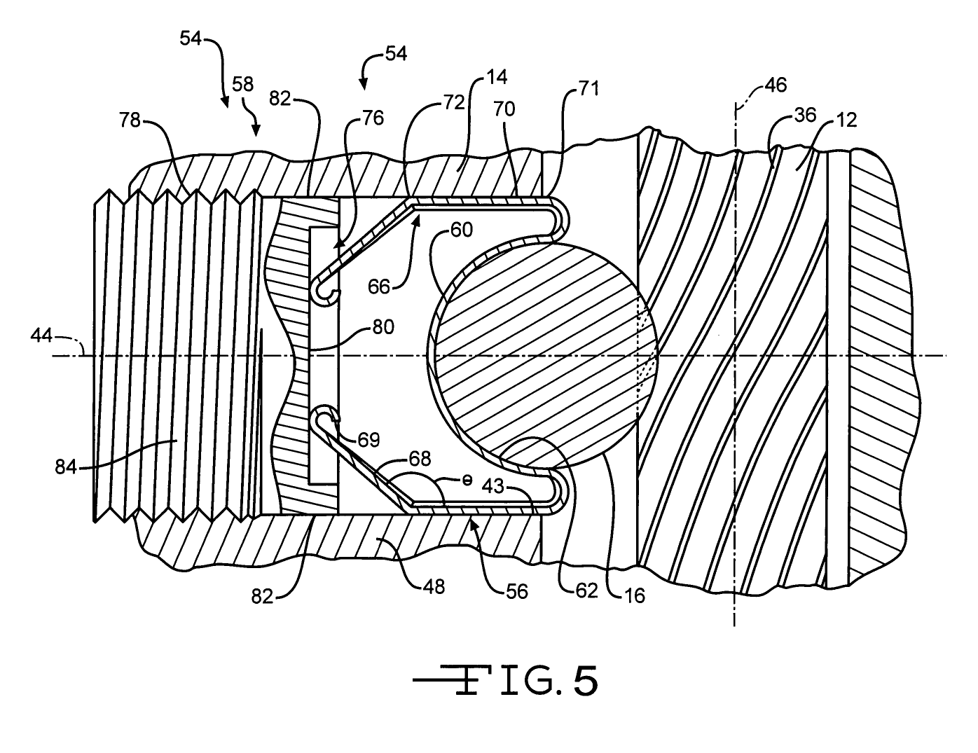

As best shown in FIG. 4, in the illustrated embodiment the arms 66 are preferably identical to one another and each includes a first portion 70 having a length L1 and a second portion 68 having a length L2. An outer surface 71 of each first portion 70 is adapted to engage the inner surface 43 of the yoke bore 48 for sliding movement therewith. To facilitate smooth movement of the yoke portion 56 within the bore 48, it is preferred that the first portion 70 of the arms 66 are coated with a Teflon impregnated bronze material. Alternatively, the yoke portion 56 can be formed from a material such as a plastic, nylon, or Kevlar-based material, and can, additionally, be coated with a Teflon or other low friction material. It should be appreciated that any suitable material can be used to form or coat the first portions 70 of the arms 66 to provide a substantially low wear contact surface between the arms 66 and the yoke bore 48.

The second portions 68 of the arms 66 are angled inwardly towards the axis 44 of the yoke bore 48 and a centerline 74 of the rack yoke assembly 54 and towards each other. The second portion 68 of the yoke arms 66 according to the present invention are operative to replace the spring 52 shown and described above with respect to the prior art rack yoke assembly of FIG. 2. Such a spring-like function is accomplished with the yoke portion 56 of the present invention based on the flexibility of the material of which the yoke portion 56 is formed. A spring function is performed by the second portion 68 of the yoke arms 66 by pivoting about a hinge or pivot point 72 formed between the first portions 70 and the second portions 68 of the arms 66. It can be appreciated that the spring constant of the second portion 68 of the arms 66 can be varied according to the desired design characteristics of the rack and pinion steering apparatus. In particular, such design qualities can be achieved for example by changing the material from which the rack yoke 56 is made, changing the thickness of the material of the rack yoke 56, changing the size of the hinge 72, etc. Alternatively, the spring rate, or spring constant of the second portion 68 of the arms 66 can be changed by modifying the respective lengths of the first portions 70 and the second portions 68. For example, if the lengths L2 of the second portions 68 were greater than the lengths L1 of the first portions 70 then the yoke arms 66 would be more flexible than if the lengths L2 of the second portions 68 were less than the lengths L1 of the first portions 70. It would be apparent to one skilled in the art, based on the disclosures contained herein, how to modify the design to achieve the desired spring characteristics of the second portions 68 of the arms 66.

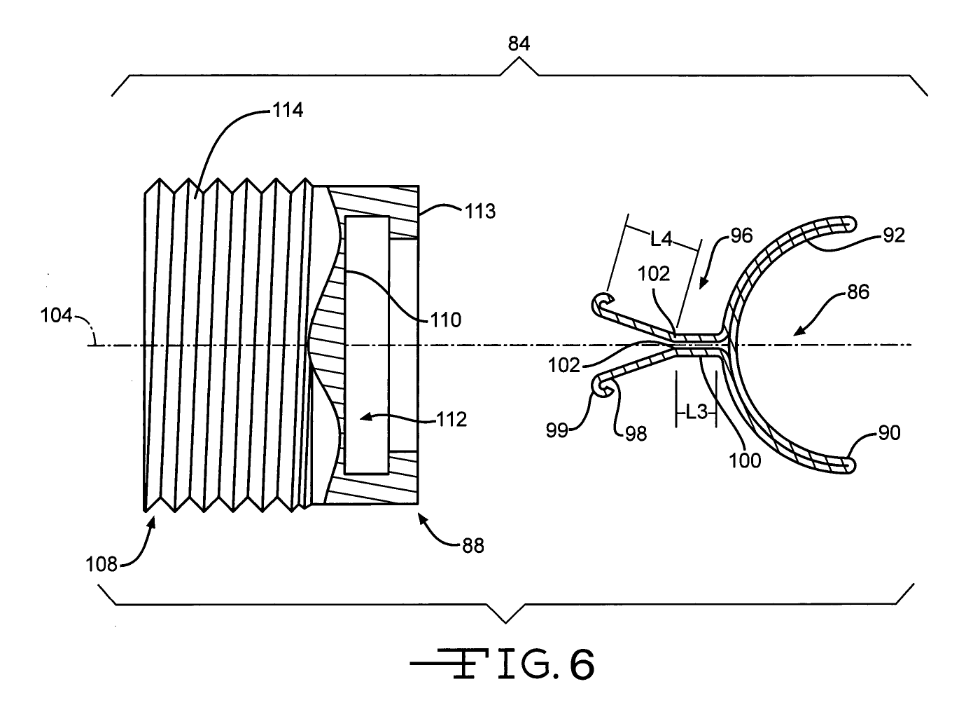

The second portions 68 of the arms 66 utilize the spring motion to apply an axially directed preloading force to urge the yoke portion 56 forcefully against the rack bar 16 in a direction from left to right as viewed in FIGS. 4 and 5. The yoke portion 56 in turn applies the preloading force to the rack bar 16 so as to hold the rack teeth 32 firmly in mesh with the helical teeth 36 on the pinion 12. The second portions 68 of the arms 66 include ends 69 having a generally curved shape so that the ends 69 can move back and forth along a support surface 80 of the carrier portion 58 as will be described in detail below. The differences in the position of the second portions 68 of the arms 66 can be seen in FIGS. 4 and 5. In FIG. 5 the second portions 68 of the arms 66 have been compressed inwardly towards each other thereby creating a spring force in an axial direction (to the right when viewing FIG. 4).

In the illustrated embodiment, the yoke portion 56 is preferably stamped formed from a spring steel material. Thus, the yoke portion 56 is preferably formed from a single continuous piece of material. Spring steel is a material that is typically of the high-carbon or alloy type and is also used in the manufacture of springs. The yoke portion 56 can be formed using a series of stamping operations, or a series of forming operations, to achieve the desired shape for the yoke portion 56. Additionally, one or more reliefs (not shown) can be cut into the spring steel material to allow the shape of the yoke portion 56 to be more easily formed. Typically, when an object is made from a steel spring material, the finished object is subsequently hardened using a heat treatment process. Such a hardening process is known to those skilled in the art.

In the illustrated embodiment, the carrier portion 58 is also preferably formed from steel and can be cast or formed using any other suitable metal forming method. The carrier portion 58 includes a spring support portion 76 and a yoke plug portion 78. The spring support portion 76 and the yoke plug portion 78 of the carrier portion 58 can be formed as an integrated unit or formed as separate pieces which are subsequently joined together by a suitable method. The spring support portion 76 can be formed having any suitable shape and configuration. However, in the illustrated embodiment, the spring support portion 76 preferably includes a substantially recessed planar support surface 80 and outer flange 82. The ends 69 of the second portion 68 of the arms 66 abut the support surface 80 and are configured to slide along the surface 80 with the compression/extension motion of the yoke portion 56. Although the ends 69 of the second portions 68 are shown having a curved shape, the ends 69 can have any suitable design such that the ends 69 can slide easily along the support surface 80. To that end, it can be appreciated that the ends 69 of the arms 66 and the support surface 80 can be made from, or coated with, a low friction material such as those which were described above. Alternatively, the spring support portion 76 can be other than illustrated. For example, the spring support portion 76 could comprise a substantially flat, i.e., non-recessed/non-flanged, planar support surface.

In the illustrated embodiment, the yoke plug portion 78 of the carrier portion 58 preferably includes threads 84 formed on an outer surface thereof that are configured to cooperate with corresponding threads formed on the inner surface 43 of the yoke bore 48 to threadably secure and retain the carrier portion 58 to the housing 14. In addition, the carrier portion 58 substantially retains the yoke portion 56 within the yoke bore 48 and provides a surface against which the spring-like second portions 68 of the arms 66 can act. Alternatively, the carrier portion 58 can be retained within the yoke bore 48 using any other suitable means if so desired.

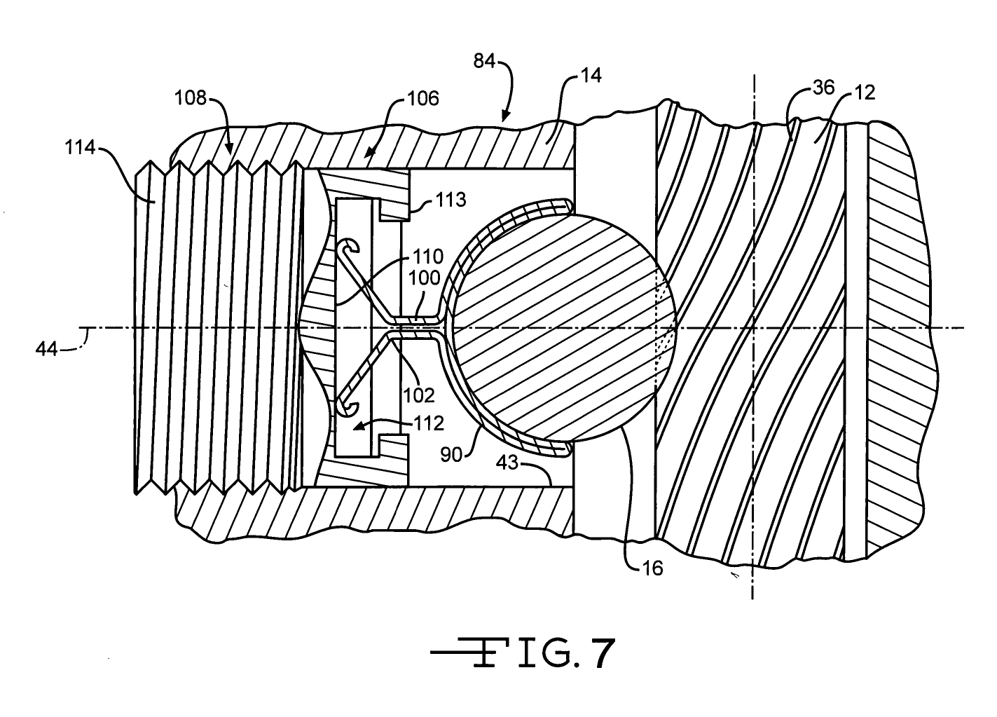

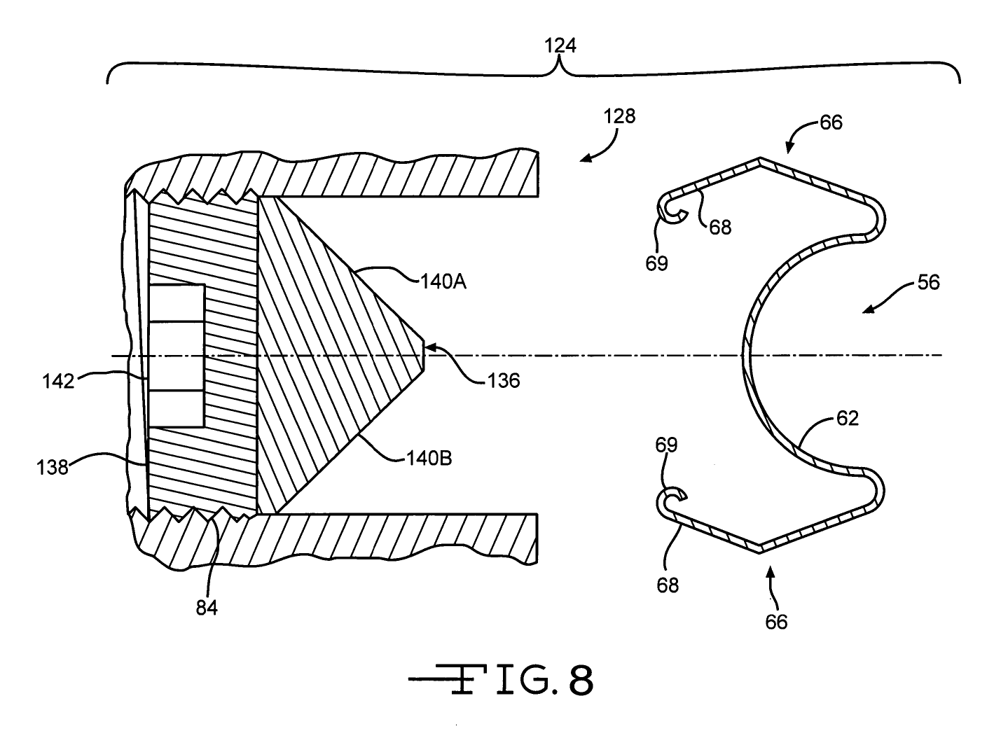

Illustrated in FIG. 6 and using like reference numbers to indicate corresponding parts, there is shown an exploded view of a rack yoke assembly 84 according to an alternate embodiment of the present invention. As shown therein, the rack yoke assembly 84 includes a yoke portion, indicated generally at 86, and a carrier portion, indicated generally at 88. The yoke portion 86 includes a generally U-shaped seat 90 that defines a rack engaging surface 92 and a pair of arms 96 that extend away from the seat 90. FIG. 7 shows the rack yoke assembly 84 installed within the housing 14 in a view similar to that of FIG. 5. It is preferred that the seat 90 be designed in a manner that is similar to that described above with respect to the seat 60 of the yoke portion 56 for a similar purpose.

Each of the arms 96 include a first portion 100, having a length L3, and a second portion 98, having length L4. Compared to the outer surfaces 71 of the first portions 70 of the yoke portion 66, the first portions 100 of the yoke portion 86 do not engage the inner surface 43 of the yoke bore 48 for sliding movement therewith. Therefore, the yoke portion 86 can be formed from any suitable material. However, in order for the arms 96 to act as a spring, the yoke portion 86 is preferably formed using similar materials to those of the yoke portion 56 described above. In the illustrated embodiment of the yoke portion 86, the second portions 98 of the arms 96 are angled outwardly away from the axis 44 of the yoke bore 48 and a centerline 104 of the rack yoke assembly 84, and away from each other. The second portion 98 of the yoke arms 96 according to this embodiment are also used to replace the spring 52 shown and described above with respect to the prior art rack yoke assembly of FIG. 2. It should be appreciated that the second portions 98 of the arms 96 act in a spring-like manner similar to that which was described above. The spring function is performed by the second portion 98 of the yoke arms 96 by pivoting about a hinge or pivot point 102 formed between the first portion 100 and the second portion 98 of the arms 96. It can be appreciated that the spring constant of the second portion 98 of the arms 96 can be varied according to the desired design characteristics of the rack and pinion steering apparatus 10. For example, if the lengths L4 of the second portions 68 were greater than the lengths L3 of the first portions 100 then the yoke arms 96 would be more flexible than if the lengths L4 of the second portions 98 were less than the lengths L3 of the first portions 100. Alternatively, as described above, the arms 96 can be made having any suitable design.

The ends 99 of the second portions 98 of the arms 96 have a generally curved shape, similar to the ends 69 of the second portions 68 of the yoke portion 56, so that the ends 99 can move back and forth along a support surface 110 as will be described in detail below. The differences in the position of the second portions 98 of the arms 96 can be seen in FIGS. 6 and 7. In FIG. 7 the second portions 98 of the arms 96 have been opened or expanded outwardly away from each other, thereby creating a spring force in an axial direction (to the right when viewing FIG. 7).

The carrier portion 88 is also preferably made of steel and can be cast or formed using any suitable method. The carrier portion 88 includes a spring support portion 106 and a yoke plug portion 108. The spring support portion 106 can be formed having any suitable shape and configuration. However, in the preferred embodiment, the spring support portion 106 includes a substantially recessed planar support surface 110 and a stepped or pocketed outer flange 112. An upper portion 113 of the flange 112 can extend inwardly towards the centerline 44 of the yoke bore 48 so as to assist with the retention of the yoke portion 96 with the carrier portion 88. The ends 99 of the second portion 98 of the arms 96 abut the support surface 110 and are configured to slide along the surface 110 with the compression/extension motion of the yoke portion 86. Although the ends 99 of the second portions 98 are shown having a curved shape, the ends 99 can have any suitable design such that the ends 99 can slide easily along the support surface 110. To that end, it can be appreciated that the ends 99 of the arms 96 and the support surface 110 can be made from, or coated with, a low friction material such as those which were described above. The yoke plug portion 108 of the carrier portion 88 preferably also includes threads 114 formed on an outer surface thereof that are configured to cooperate with corresponding threads formed on the inner surface 43 of the yoke bore 48 to threadably retain the carrier portion 88 with the housing 14. In addition, the carrier portion 88 substantially retains the yoke portion 86 within the yoke bore 48 and provides a surface against which the spring second portion 98 of the arms 96 can act. It should be appreciated that the carrier portion 88 can be retained within the yoke bore 48 using any suitable means.

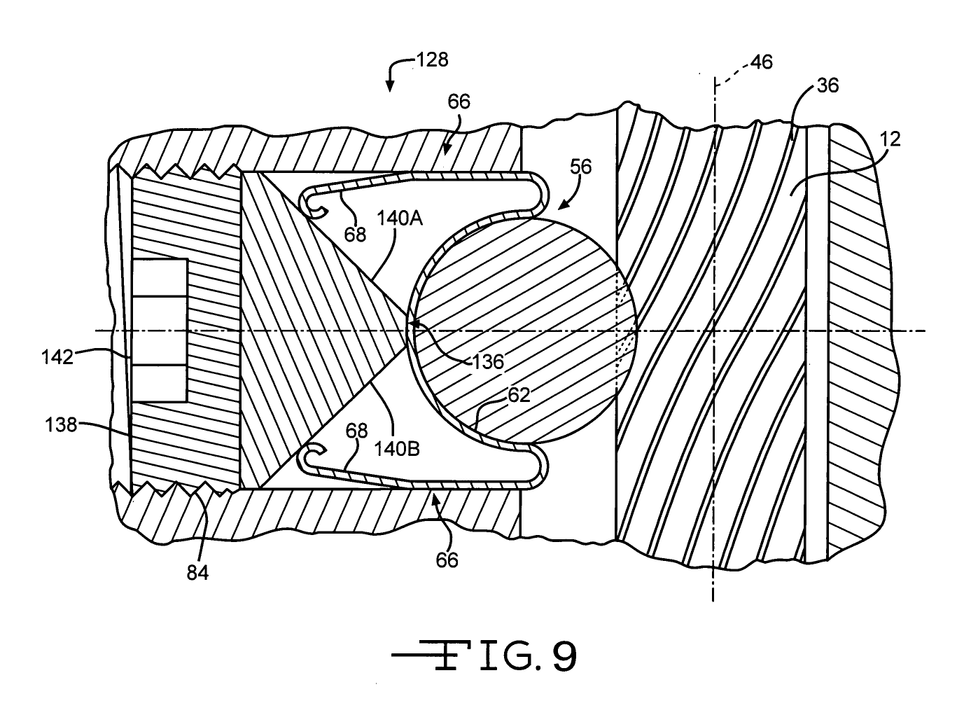

Illustrated in FIG. 8 and using like reference numbers to indicate corresponding parts, there is shown an exploded view of a rack yoke assembly 124 according to yet another alternate embodiment of the present invention. As shown therein, the rack yoke assembly 124 includes the yoke portion 56 and a carrier portion, indicated generally at 128. In this embodiment, the carrier portion 128 includes a spring support portion 136 and a yoke plug portion 138. In the illustrated embodiment, the spring support portion 136 includes a pair of substantially flat support surface 140A and 140B adapted to receive the ends 69 of the second portions 68 of the arms 66 of the yoke portion 56. The ends 69 of the second portions 68 of the arms 68 abut the support surfaces 140A and 140B and are configured to slide along the surfaces 140A and 140B with the compression/extension motion of the yoke portion 56. The differences in the position of the second portions 68 of the arms 66 can be seen in FIGS. 8 and 9. In FIG. 9 the second portions 68 of the arms 66 have been opened or expanded outwardly away from each other thereby creating a spring force in an axial direction (to the right when viewing FIG. 9).

In the illustrated embodiment, the yoke plug portion 138 of the carrier portion 128 preferably also includes threads 84 formed on an outer surface thereof that are configured to cooperate with corresponding threads formed on the inner surface 43 of the yoke bore 48 to threadably retain the carrier portion 88 with the housing 14. Also, in this embodiment, the yoke plug portion 138 includes an internal drive socket 142. Alternatively, the structure of the carrier portion 128 can be other than illustrated. For example, the spring support portion 136 and the yoke plug portion 138 can be integral or of one-piece and/or the support surface of the yoke plug portion 138 can be formed having any suitable shape and configuration.

It can be appreciated that a rack and pinion steering apparatus for differently sized vehicles can include a rack bar 16 having different outer diameters. Therefore, according to the present invention, there is also a system for assembling a yoke portion 56, 86 with an associated carrier portion 58, 88, 128 depending on the size of the rack bar 16. In the preferred embodiment, the yoke portion 56, 86 is sized to closely correspond to the size of the rack bar 16. Particularly, the associated rack engaging surface 62, 92 is designed having a curvature that closely matches the outer diameter of the rack bar 16. Depending on the diameter of the rack bar 16, a yoke portion 56, 86 is preferably selected wherein the curvature or profile of the rack engaging surface 62, 92 provides the greatest amount of supporting engagement when the rack yoke assembly 54, 84 is forced against the rack bar 16. In the preferred embodiment, the carrier portions 58, 88, 128 are made having a substantially similar size thereby fitting within the rack housing 14. Therefore, to customize the rack yoke assembly 54, 84 to the selected rack size, a plurality of yoke portions 56, 86 can be provided wherein each of the yoke portions 56, 86 has a unique size which closely corresponds to the selected rack bar 16. In order for an assembly operator to identify which yoke portion 56, 86 for the rack yoke assembly 54, 84 is to be selected to correspond to the specific rack size, it is preferred that the yoke portions 56, 86 have an identifiable physical characteristic to facilitate the identification. In the preferred embodiment, the differently sized yoke portions 56, 86 can have unique colors to identify a particular size; although it can be appreciated that any other visual and physical characteristic can be used for size identification purposes, such as for example printing on the surface of the yoke portion 56, 86, labels, textures, or other identifying indicia or feature.

It should also be appreciated that the spring support portions 76, 106, 136 of the carrier portions 58, 88, 128, respectively, can include other features than those disclosed, such as a sloped or angled spring support portion to facilitate the sliding movement of the arms 66, 96 of the yoke portions 56, 86, and therefore the biasing of the yoke portions 56, 86.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A rack and pinion steering gear comprising:
a housing having an axially extending passage and a yoke bore that extends perpendicular to the axially extending passage and connects with the axially extending passage within the housing, the yoke bore having a yoke bore axis;
a pinion gear rotatably mounted in the housing, the pinion gear having teeth;
a rack bar extending through the axially extending passage of the housing and being movable relative to the pinion gear, the rack bar having teeth in meshing engagement with the teeth of the pinion gear; and
a rack yoke assembly located in the yoke bore of the housing for at least partially supporting and guiding axial movement of the rack bar relative to the pinion gear, the yoke assembly including a yoke portion having a seat engaging the rack bar, and a pair of arms extending away from the seat portion, wherein the arms bias the yoke assembly towards the rack bar.

2. The rack and pinion steering gear of claim 1 wherein the yoke portion is formed from a single continuous piece of material.

3. The rack and pinion steering gear of claim 2 wherein the yoke portion is formed from a spring steel material.

4. The rack and pinion steering gear of claim 1 wherein each of the arms includes a first portion and a second portion wherein an outer surface of the first portion engages an inner surface of the yoke bore for sliding movement therewith.

5. The rack and pinion steering gear of claim 4 wherein the outer surface of the first portions are coated with a low-friction material.

6. The rack and pinion steering gear of claim 4 wherein the second portions of the arms are angled inwardly towards each other.

7. The rack and pinion steering gear of claim 4 wherein the second portions of the arms are angled outwardly away from each other.

8. The rack and pinion steering gear of claim 1 further comprising a carrier portion, the carrier portion having a spring support portion and a yoke plug portion, wherein ends of the arms engage the spring support portion for sliding movement therewith.

9. The rack and pinion steering gear of claim 8 wherein the yoke portion and the carrier portion are formed as one-piece.

10. The rack and pinion steering gear of claim 8 wherein the yoke portion and the carrier portion are formed as separate pieces.

11. A rack yoke assembly adapted for use in a rack and pinion steering assembly, the rack yoke assembly comprising:
a yoke portion having a seat and a spring portion formed from a single continuous piece of material; and
a carrier portion configured to retain the rack yoke portion with the rack and pinion steering assembly.
wherein the spring portion of the rack yoke portion includes at least a pair of arms having first portions and second portions, wherein the second portions are configured to pivot about a hinge formed between the first portions and second portions.

12. The rack yoke assembly of claim 11 wherein the carrier portion defines a low friction support surface, the support surface being configured to slidably support ends of the second portions of the arms.

13. The rack yoke assembly of claim 11 wherein the yoke portion and the carrier portion are formed as one-piece.

14. The rack yoke assembly of claim 11 wherein the yoke portion and the carrier portion are formed as separate pieces.

15. The rack yoke assembly of claim 11 wherein the yoke portion is formed from a single continuous piece of material.

16. The rack yoke assembly of claim 15 wherein the yoke portion is formed from a spring steel material.

17. The rack yoke assembly of claim 11 wherein at least an outer surface of the first portions of the arms are coated with a low-friction material.

18. The rack yoke assembly of claim 11 wherein the second portions of the arms are angled inwardly towards each other.

19. The rack yoke assembly of claim 11 wherein the second portions of the arms are angled outwardly away from each other.

20. A rack yoke assembly adapted for use in a rack and pinion steering assembly, the rack yoke assembly comprising:
a yoke portion having a seat and a spring portion; and
a carrier portion configured to retain the rack yoke portion with the rack and pinion steering assembly.
wherein the spring portion of the rack yoke portion includes a pair of arms having first portions and second portions, wherein the second portions are configured to pivot about a hinge formed between the first portions and second portions.
